(19) United States
(12) Patent Application Publication
(10) Pub. No.: US 2014/0172672 A1
(43) Pub. Date: Jun. 19, 2014

(54) SYSTEM AND METHOD OF A PLATFORM FOR CROSSING BONDS

(71) Applicant: Axis Trading Solutions, Inc., Wellesley, MA (US)

(72) Inventor: Charles P. Moore, Wayland, MA (US)

(73) Assignee: Axis Trading Solutions, Inc., Wellesley, MA (US)

(21) Appl. No.: 14/105,862

(22) Filed: Dec. 13, 2013

Related U.S. Application Data
(60) Provisional application No. 61/737,503, filed on Dec. 14, 2012.

(51) Int. Cl. G06Q 40/04

(52) U.S. Cl. CPC G06Q 40/04
USPC 705/37

(57) ABSTRACT

This disclosure provides a unique process for firms wishing to cross bonds internally, from one customer account to another. This process allows the selling firm to list the bonds for sale on the bond auction platform and simultaneously to bid on the listed bonds. In doing so, the seller must also have a willingness to sell the bonds away to any firm that outbids the crossing price. By bidding on the seller's own bonds, and then exposing that bid on the platform, the selling firm is able to expose the bid (the cross price) to the market and thereby receive market validation of the price. If another firm chooses to out-bid the seller's bid, the bonds will trade away to the other firm.

### CROSS-REFERENCE TO RELATED APPLICATIONS

This application claims the benefit of the following provisional applications, each of which is hereby incorporated by reference in its entirety: U.S. Provisional Application No. 61/737,503, filed Dec. 14, 2012.

### BACKGROUND

1. Field

This disclosure relates to investment management, and more particularly to a platform for enabling crossing bonds.

2. Description of the Related Art

Separately Managed Accounts (SMA's) have grown in popularity in recent years, with total assets in this class increasing from $430 billion in 2009 to roughly $800 billion in 2011. Much of the growth has been in Municipal Bond holdings, as wealthy investors seek the more personalized attention they receive with an individually managed account. Many also want to take advantage of the tax-exempt status of interest earned on municipal holdings.

Today, many SMA managers have billions under management, made up of several thousand individual accounts. Each account is treated as a unique portfolio and the needs of individual investor change quite frequently, depending upon their unique investment goals. In the normal course of business, a common issue for SMA managers is the need to raise cash for a client by liquidating assets from their account. When this need arises, the SMA manager often has another client on whose behalf he would like to buy the bonds that are being liquidated. This practice is commonly referred to as an internal “cross”.

When crossing bonds internally, the investment manager faces a compliance issue that requires him to be fair to buyer and seller, both of whom are his client. In order to be fair, investment managers must get market validation on their crossing price, and they may do that by selling the bonds to a bond dealer, and then buying them back. This process requires the firm to pay a dealer mark-up or ‘spread’, thus driving up the price for the buyer and reducing the proceeds to the seller.

There remains a need for a platform enabling users to cross bonds that exposes the transaction to the market and enables validation of the selling price while eliminating dealer mark-up.

### SUMMARY

This disclosure provides a unique process for firms wishing to cross bonds internally, from one customer account to another. This process allows the selling firm to list the bonds for sale on the bond auction platform and simultaneously to ‘bid his own bonds’, that is, bid on the listed bonds on behalf of another customer. In doing so, the seller must also have a willingness to sell the bonds ‘away’ to any firm that outbids the crossing price. By bidding on the seller's own bonds, and then exposing that bid on the platform, the selling firm is able to expose the bid (the ‘cross price’) to the market and thereby receive market validation of the price. If another firm chooses to out-bid the seller's bid, the bonds will ‘trade away’ to another firm.

This disclosure provides a unique method for entering bonds to be crossed with the seller's bid on the seller's own bonds. In addition, the platform enables the bonds to be made available to prospective bidders/buyers such that they appear the same as any other bonds available on the bond auction platform. For all bonds set up to cross on the bond auction platform, the ‘will trade’ indicator light will be ‘on’, signaling to bidders that the Seller's Reserve price has been met and the bonds ‘will trade’ at the Auction End Time.

A process for crossing bonds may include listing a bond for sale on a bond auction platform on behalf of a first user, wherein the listed bond is available to be bid upon by users of the platform and submitting a bid on the bond auction platform for the listed bond on behalf of a second user, wherein exposing the bid on the platform enables receiving market validation for at least one of a price and a yield indicated in the bid. The process may also include receiving a bid from at least one other user for the listed bond and trading the listed bond to the at least one other user if the bid by the at least one other user is greater than the bid made on behalf of the second user. The process may further include setting a reserve price for the listed bond.

A process for crossing bonds may include listing a bond for sale on a bond auction platform on behalf of a first user, wherein the listed bond is available to be bid upon by users of the platform and submitting a bid on the bond auction platform for the listed bond on behalf of a second user, wherein exposing the bid on the platform enables receiving market validation for at least one of a price and a yield indicated in the bid. The process may also include trading the listed bond to the second user if no other bids are received or if the second user is not outbid. The process may further include setting a reserve price for the listed bond.

In an aspect, a computer program product embodied in a non-transitory computer readable medium that when executing on one or more computers, performs steps which may include listing a bond for sale on a bond auction platform on behalf of a first user, wherein the listed bond is available to be bid upon by users of the platform, substantially simultaneously with listing the bond for sale, submitting a bid on the bond auction platform for the listed bond on behalf of a second user, wherein the first user and the second user of the platform are customers of a single brokerage house or financial institution, receiving a bid from at least one other user for the listed bond, the at least one other user being an independent third party and not a customer of the single brokerage house of financial institution for at least the bond auction, receiving the bid on the platform provides market validation for at least one of a price and a yield indicated in the bid, and executing a trade involving the listed bond based on comparison of the submitted bid with at least one received bid. A further step may include setting a reserve price for the listed bond.

In an aspect, a computer program product embodied in a non-transitory computer readable medium that, when executing on one or more computers, performs steps which may include listing a bond for sale on a bond auction platform on behalf of a first user, wherein the listed bond is available to be bid upon by users of the platform, substantially simultaneously with listing the bond for sale, submitting a bid on the bond auction platform for the listed bond on behalf of a second user, wherein the first user and the second user are customers of a single brokerage house or financial institution, wherein exposing the bid on the platform enables receiving market validation for at least one of a price and a yield indicated in the bid, and trading the listed bond to the second user if the second user is not outbid. The steps may further include setting a reserve price for the listed bond.

These and other systems, methods, objects, features, and advantages of the present disclosure will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The disclosure and the following detailed description of certain embodiments thereof may be understood by reference to the following figures:

FIG. 1 depicts a process for crossing bonds internally.

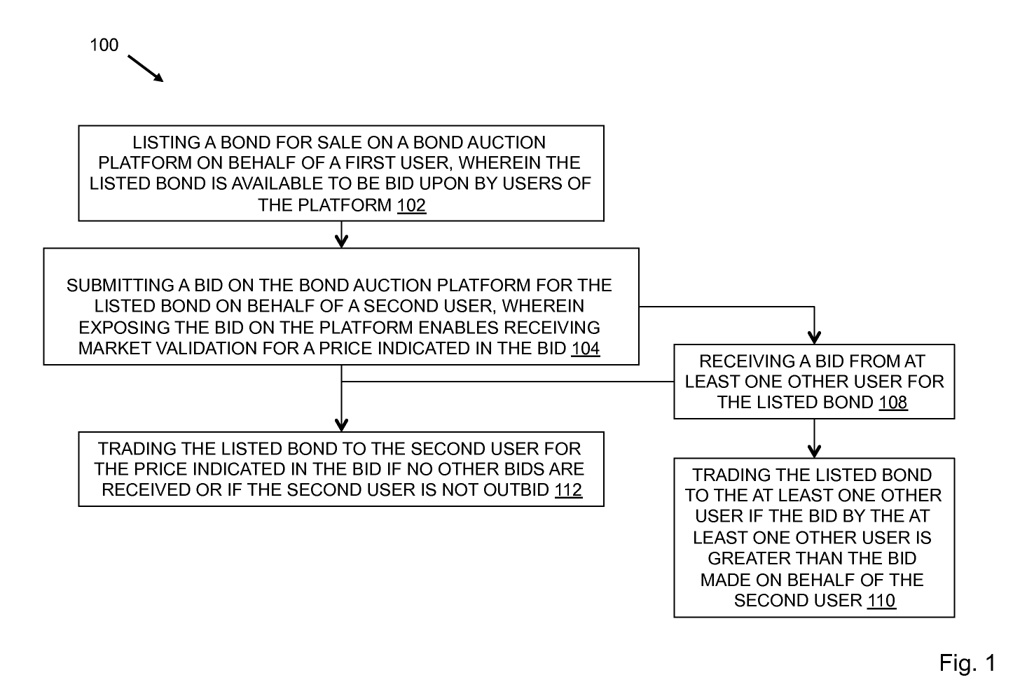

### DETAILED DESCRIPTION

Disclosed herein is a process for entities wishing to cross bonds internally, that is, sell bonds from one customer account to another customer account. In this disclosure, the customers are both customers of the same brokerage house or financial institution that is hosting the trading platform or bond auction platform. The bond auction platform enables sellers to solicit bids from both buy-side and sell-side firms. In the process, a seller lists a bond for sale on a bond auction platform on behalf of a first customer 102. This bond may be known as a cross item in this Specification. The listed bond is available to be bid upon by any user of the platform. Then, the seller submits a bid on the bond auction platform for the listed bond on behalf of a second customer 104. In this way, the bid is exposed on the platform, which enables receiving market validation for the price or the yield indicated in the bid. If no other bids are received or if the second customer is not outbid by other users of the platform, then the bond is traded to the second customer for the price or yield indicated in the bid 112, wherein the trade may occur through the sponsoring broker dealer. However, bids may be received for the listed bond from other users of the platform 108. If the bid by the other user is greater than the bid made on behalf of the second customer, then the listed bond is traded to the other user 110. As part of the process, the seller may set a reserve price for the listed bond.

The process for crossing bonds may be executed on a bond auction platform wherein other bond trades that do not involve the disclosed process are also taking place. In embodiments, the platform may not host other non-crossing bond transactions. A cross item may be presented in a similar fashion to any other auction item on the bond auction platform. When the auction begins, the system may generate a first bid. The first bid is the seller's bid, also known as the cross price. After this bid is generated, a “Will Trade” indicator may be activated, indicating that the seller's Reserve Price has been met. When the auction ends, a trade is generated. If the seller has been out-bid by another party, the bonds will be traded the outbidding party. If the Seller has not been outbid or no other bids were made, the bonds will cross internally from the first customer's account, through the sponsoring broker dealer, to the second customer's account. In certain embodiments, the Seller may be committed to selling the bond once it has been listed on the bond auction platform.

Net Reserve may be entered as a Price or Yield, but not both in embodiments. Net Reserve Price is the net price that commits the Seller to sell the item. If a bidder hits the Gross Reserve Price (Net Reserve Price+Commission) the “Will Trade” indicator is displayed on bidding screens, indicating the Seller “Will Trade” at the auction End Time and the bonds will automatically move into the execution process with a status of “pending” at the auction End Time. Net Trade Now may be entered as a Price or Yield, but not both in embodiments. Net Trade Now Price is the net price that commits the Seller to sell the item. If a bidder hits the Gross Trade Now Price (Net Trade Now Price+Commission), the bonds will automatically move into the execution process with a status of “pending” at the time the bid is received and the auction will end immediately. If neither condition is met, the Seller reserves the right to decide if the bonds will trade, and the Seller can make that determination between the End Time of the auction and Firm Time.

The reserve price may be editable. For example, if the bid has not reached the ‘Reserve Price’ and has not otherwise ended, the seller may edit the price to establish a Reserve or a Trade Now price. If the bid has not reached the ‘Reserve Price,’ the seller may cancel the auction.

The bond auction platform may include a dashboard to view bonds that a user or entity is watching, bidding on, selling, pending trade, traded, crossed internally or traded away, and the like; auctions that active or scheduled; reports/analysis on trades; and alerts. The dashboard may be used to add items to sell or cross. Items to sell or cross may be added manually or imported from a file, such as a spreadsheet file. Indicators, such as colors, icons, font changes, etc., may be used to indicate if the user is the high bidder, if the user has been outbid or if the user has not bid. A change in the ‘Will Trade’ column on the dashboard, such as display of a green light or other icon, will appear when the Seller's reserve has been met, indicating that the bonds will trade at the auction End Time. Bids may be expressed in terms of yield, yield minus a concession or price.

If the ‘WILL TRADE’ indicator is ‘OFF’, the Seller has not made a commitment to trade, as no Reserve has been set (or reached). If the bid reaches an acceptable level, and the Seller wishes to indicate that the bonds “will trade” at the auction End Time (the same as setting a ‘Reserve’), the Seller may indicate such willingness to trade by clicking the ‘OFF’ button and turning it to ‘ON’. The Seller may be asked to confirm when making this commitment to trade. The impact of this action will be to turn on the green “WILL TRADE” light for this item. If the Seller has already set a ‘Reserve’ on this item and a bid has hit that reserve, the button may be turned ‘ON’ automatically. Once the button is ‘ON’, it may not be turned ‘OFF”.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, cloud servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, cloud servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents referenced herein are hereby incorporated by reference.

What is claimed is:

1. A computer program product embodied in a non-transitory computer readable medium that, when executing on one or more computers, performs steps comprising:
listing a bond for sale on a bond auction platform on behalf of a first user, wherein the listed bond is available to be bid upon by users of the platform;
substantially simultaneously with listing the bond for sale, submitting a bid on the bond auction platform for the listed bond on behalf of a second user, wherein the first user and the second user of the platform are customers of a single brokerage house or financial institution;
receiving a bid from at least one other user for the listed bond, the at least one other user being an independent third party and not a customer of the single brokerage house or the financial institution for the bond auction, receiving the bid on the platform provides market validation for at least one of a price and a yield indicated in the bid; and
executing a trade involving the listed bond based on comparison of the submitted bid with at least one received bid.

2. The computer program product of claim 1, further comprising, setting a reserve price for the listed bond.

3. A computer program product embodied in a non-transitory computer readable medium that, when executing on one or more computers, performs steps comprising:
listing a bond for sale on a bond auction platform on behalf of a first user, wherein the listed bond is available to be bid upon by users of the platform;
substantially simultaneously with listing the bond for sale, submitting a bid on the bond auction platform for the listed bond on behalf of a second user, wherein the first user, the second user and users of the platform are customers of a single brokerage house or financial institution, wherein exposing the bid on the platform enables receiving market validation for at least one of a price and a yield indicated in the bid; and
trading the listed bond to the second user if the second user is not outbid.

4. The computer program product of claim 3, further comprising, setting a reserve price for the listed bond.
